(19) United States
(12) Patent Application Publication
(10) Pub. No.: US 2011/0168266 A1
(43) Pub. Date: Jul. 14, 2011

(54) Closed System Water Conservation Apparatus

(76) Inventor: Brett Fiora, Hendersonville, NC (US)

(21) Appl. No.: 12/687,323

(22) Filed: Jan. 14, 2010

(51) Int. Cl. F15D 1/00; F16K 31/00

(52) U.S. Cl. 137/1; 137/597; 137/624.11

(57) ABSTRACT

A closed system water conservation apparatus for connection to a hot water supply and delivery system includes a first valve disposed along the hot water conduit upstream of the delivery opening for selectively directing water between a first path for receipt and distribution by the delivery opening and a second path for use by a toilet; a second valve disposed along the hot water conduit upstream of the toilet, the second valve being in fluid communication with the cold water source and the first valve for selectively directing water to the toilet from at least one of the second path and the cold water source, and a water transfer conduit extending in fluid communication between the first valve and the second valve along the second path for intermediate cold water flow therethrough between the first valve and the second valve.

### BACKGROUND OF THE INVENTION

The present invention relates broadly to water conservation apparatus and, more particularly, to a water conservation apparatus for recovering and using intermediate cold water from a household or other water-use event.

Residential and commercial building water distribution systems distribute water to various fixtures, including sinks, bathtubs, showers, dishwashers and washing machines, that are located throughout the house or industrial building. The typical water distribution system brings water in from an external source, such as a city main water line or a private water well, to the internal water distribution piping system. The water from the external source is typically either at a cold or cool temperature. One segment of the piping system takes this incoming cold water and distributes it to the various cold water connections located at the fixture where it will be used (i.e., the cold water side of the faucet at the kitchen sink). Another segment of the piping system delivers the incoming cold water to a water heater which heats the water to the desired temperature and distributes it to the various hot water connections where it will be used (i.e., the hot water side of the kitchen faucet). At the fixture, cold and hot water either flow through separate hot and cold water control valves that are independently operated to control the temperature of the water into the fixture by controlling the flow rate of water from the valves or the water is mixed at a single valve that selectively controls the desired temperature flowing into the fixture.

A well known problem common to most home and industrial water distribution systems is that hot water is not always readily available at the hot water side of the fixture when it is desired. This problem is particularly acute in water use fixtures that are located a distance from the hot water heater or in systems with poorly insulated pipes. When the hot water side of these fixtures is left closed for some time (i.e., overnight), the hot water in the hot water segment of the piping system sits in the pipes and cools. As a result, the temperature of the water between the hot water heater and the fixture lowers until it becomes cold or at least tepid. When opened again, it is not at all uncommon for the hot water side of such a fixture to supply cold water through the hot water valve when it is first opened and for some time thereafter. At the sink, bathtub or shower fixture located away from the water heater, the person desiring to use the fixture will either have to use cold or tepid water instead of hot water or wait for the distribution system to supply hot water through the open hot water valve. Most users have learned that to obtain the desired hot water, the hot water valve must be opened and left open for some time so that the cool water in the hot water side of the piping system will flow out ahead of the hot water. For certain fixtures, such as dishwashers and washing machines, there typically is no method of “draining” away the cold or tepid water in the hot water pipes prior to utilizing the water in the fixture.

The inability to have hot water at the hot water side of the fixture when it is desired creates a number of problems. One problem is having to utilize cold or tepid water when hot water is desired. This is a particular problem for the dishwasher and washing machine fixtures in that hot water is often desired for improved operation of those fixtures. As is well known, certain dirty dishes and clothes are much easier to clean in hot water as opposed to cold or tepid water. Even in those fixtures where the person can let the cold or tepid water flow out of the fixture until it reaches the desired warm or hot temperature, there are certain problems associated with such a solution. One such problem is the waste of water that flows out of the fixture through the drain and, typically, to the sewage system. This good and clean water is wasted. This waste of water is compounded when the person is inattentive and hot water begins flowing down the drain and to the sewage system. Yet another problem associated with the inability to have hot water at the hot water valve when needed is the waste of time for the person who must wait for the water to reach the desired temperature.

In a house or other area that includes a shower, sink or other hot water dispensing facility and a hot water supply, it is sometimes found that the hot water supply is disposed remotely from the ultimate point of water use. The discussion herein regarding intermediate cold water applies whether the structure is a house, a gymnasium, a ship or any other structure providing hot water facilities disposed a predetermined distance away from the point of water use.

Once water use is discontinued, a primary flow valve is typically closed at the point of use thereby stopping the flow of water and trapping a volume of water between the water heater and the primary flow valve. Over the time between hot water use events, the water intermediate the water heater and the primary flow valve can become cold in the sense that it is not heated. Throughout the discussion, the terms “hot water” and “cold water” will be used. It is to be understood that these terms are used in a generalized manner and that the hot water is considered to be water emerging from a hot water heater and elevated to above ambient temperature. Cold water is considered to be water from a central water supply that is not heated by a water heater. Cold water is not necessarily refrigerated but is considered cold with respect to the water effluent from the water heater. Water that has lost heat in the conduits, lines or piping intermediate the water heater and the primary flow valve is discussed herein as “intermediate cold water.” It is the intermediate cold water that is wasted down the drain while a person using the water is waiting for the hot water to arrive or else is used with some discomfort yet essentially serves no useful purpose.

Accordingly, there exists a need for an apparatus that will recover the intermediate cold water from shower lines, sink lines or other hot water lines where water within the lines has become cold such that the intermediate cold water can be applied to a useful purpose.

### SUMMARY OF THE INVENTION

It is accordingly an object of the present invention to provide a water conservation apparatus that will provide a closed system for recovery of intermediate cold water which may then be put to use.

It is another option of the present invention to provide a water conservation apparatus that will divert the intermediate cold water from the shower and direct that cold water to a toilet flush tank.

It is yet another option of the present invention to provide a storage system which operates as a closed system for recovering the intermediate cold water and storing it for later use in a non-toilet environment.

To those ends, the present invention is directed to a closed system water conservation apparatus for connection to a hot water supply and delivery system including a hot water conduit in communication with a hot water heater and a delivery opening wherein standing water intermediate the hot water heater and the delivery opening can become cold water. Also required is a cold water supply and delivery system, including a cold water conduit in fluid communication with a cold water source and a toilet having a flush water tank. The water conservation apparatus includes a first valve disposed along the hot water conduit upstream of the delivery opening for selectively directing water between a first path for receipt and distribution by the delivery opening and a second path for use by the toilet. Further, a second valve is disposed along the hot water conduit upstream of the toilet, the second valve being in fluid communication with the cold water source and the first valve for selectively directing water to the toilet from at least one of the second path and the cold water source. The present invention further includes a water transfer conduit extending in fluid communication between the first valve and the second valve along the second path for intermediate cold water flow therethrough between the first valve and the second valve, wherein the water conservation apparatus is configured for selectively directing intermediate cold water from the hot water conduit to the second primary flow valve via the water transfer conduit and wherein the second valve is configured for selectively receiving the intermediate cold water from the hot water conduit via the first valve and directing the intermediate cold water to the flush water tank, and for selectively directing hot water from the hot water source to the delivery opening via the hot water conduit.

Preferably, the water conservation apparatus further includes a thermometer in operational communication with the hot water conduit disposed upstream of the first valve. The thermometer includes an arrangement for presenting an indication of a temperature of the hot water conduit thereby providing an indication of a temperature of a fluid within the conduit. Further, the thermometer may be a human readable thermometer adhesively fixed to the hot water conduit and configured for presenting an indication of a temperature of a fluid within the conduit.

It is preferred that the first valve includes a temperature sensor disposed in operational communication with the hot water conduit upstream of the first valve for sensing a temperature within the hot water conduit upstream of the first valve and an automatic valve operator arrangement in operational communication with the temperature sensor for operating the first valve to direct water from the first path to the second path when the temperature sensor has sensed a temperature indicating cold water present in the hot water conduit upstream of the first valve, and for operating the valve to direct water from the first path to the delivery opening when the temperature sensor has sensed a temperature indicating hot water present in the hot water conduit upstream of the first valve.

It is further preferred that the first valve includes a timer for counting a predetermined elapsed time and producing a valve control signal responsive to the completion of the predetermined elapsed time, the timer being disposed in operational communication an automatic valve operator arrangement for operating the first valve to direct water from the first path to the second path when the timer is started and operating the valve to direct water from the second path to the first path and to the delivery opening when the control signal indicates completion of the predetermined elapsed time.

The present invention further preferably includes a holding tank disposed along the water transfer conduit in fluid communication therewith for selective retention of intermediate cold water from the hot water conduit via the first valve and the water transfer conduit. The present invention further preferably includes a pump in operational communication with the holding tank for selectively moving water from the holding tank to the toilet tank.

The present invention can also be described as a closed system water conservation apparatus for connection to a hot water supply and delivery system including a hot water conduit in communication with a hot water heater and a delivery opening. The water conservation apparatus includes a trigger arrangement operatively associated with the hot water conduit, the trigger arrangement including at least one of an arrangement for determining a temperature of fluid within the hot water conduit and an arrangement for determining an elapsed time, the trigger arrangement being configured for producing a trigger signal responsive to one of at least one predetermined temperature and a predetermined elapsed time.

The present invention also includes a first valve disposed along the hot water conduit upstream of the delivery opening along a first path to the delivery opening for selectively directing intermediate cold water between the first path for receipt and distribution by the delivery opening and a second path, the first valve including an automatic valve operator in operational communication with the trigger arrangement for operating the first valve when the control signal indicates whether at least one of the timers has been started and the temperature of the water is at a first predetermined value thereby indicating intermediate cold water is present in the hot water conduit and for operating the first valve when at least one of the temperature is at a second predetermined value and the timer indicating that a predetermined elapsed time has passed thereby indicating that hot water is present in the hot water conduit upstream of the delivery opening to direct water to the delivery opening.

Also required is a holding tank disposed along the second path in fluid communication with the first valve for selective retention of intermediate cold water from the hot water conduit via the first valve and a water transfer conduit wherein the water conservation apparatus is configured for selective direction of intermediate cold water from the hot water conduit to the holding tank via the water transfer conduit, and for selectively directing hot water from the hot water source to the delivery opening via the hot water conduit responsive to control signals from the trigger arrangement.

Preferably, the trigger arrangement includes a thermometer in operational communication with the hot water conduit disposed upstream of the first valve, the thermometer having an arrangement for presenting an indication of a temperature of the hot water conduit thereby providing an indication of a temperature of a fluid within the conduit. The thermometer may be a human readable thermometer adhesively fixed to the hot water conduit and configured for presenting an indication of a temperature of a fluid within the conduit.

The first valve may also include a timer for counting a predetermined elapsed time and producing a valve control signal responsive to the completion of the predetermined elapsed time. The timer may be disposed in operational communication with an automatic valve operator arrangement for operating the first valve when a valve control signal indicates completion of the predetermined elapsed time.

The present invention is also directed to a method for water conservation using the foregoing apparatus. Accordingly, the present invention is directed to a method for conserving water using a closed system water conservation apparatus for connection to a hot water supply and delivery system including a hot water conduit in communication with both a hot water heater and a delivery opening defining a first water path with the water delivery being controlled by a primary flow valve. The method includes the steps of:
initiating water flow using the primary flow valve;
operating a first valve disposed along the hot water conduit upstream of the delivery opening to divert water from the first path to a second path leading to a storage vessel to prevent water from exiting the delivery opening and for retaining the water in the storage vessel for later use;
monitoring water temperature using a temperature sensing arrangement disposed along the hot water conduit upstream of the delivery opening for sensing a temperature of fluid within the hot water conduit; and
operating the first valve when an observed temperature of the water within the hot water conduit reaches a predetermined temperature to direct water to the delivery opening.

Preferably, the method further includes the step of operating a second valve disposed along the second path to direct the intermediate cold water from the second path to a storage vessel. It is preferred that the method further includes the step of operating a second valve disposed along the second path to direct the intermediate cold water from the second path to a storage tank operatively associated with a flush toilet.

It is also preferred that the method further includes the step of operating a second valve disposed along the second path to direct the intermediate cold water from the second path to a holding tank for later use.

The step of monitoring water temperature using a temperature sensing arrangement may include using a temperature sensor operatively connected to a valve control device for controlling the operative disposition of the first valve and the step of operating the first valve may include changing the operative disposition of the valve responsive to at least one predetermined temperature set point as determined by the temperature sensing arrangement.

By the above, the present invention provides a water conservation apparatus and method that can recover the intermediate cold water from a shower or sink line and store the cold water for later use operating as a closed system.

### BRIEF DESCRIPTION OF THE DRAWINGS

FIG. 1 is a perspective view of a water conservation apparatus according to one preferred embodiment of the present invention;

FIGS. 2A and 2B are each a perspective view of a respective version of the flow system of the water conservation apparatus illustrated in FIG. 1;

FIG. 3 is a diagrammatic view of the water conservation apparatus illustrated in FIG. 1;

FIG. 4 is a diagrammatic view of a water conservation apparatus according to another preferred embodiment of the present invention; and

FIGS. 5A and 5B are each a diagrammatic view of a water conservation apparatus according to another preferred embodiment of the present invention.

### DESCRIPTION OF THE PREFERRED EMBODIMENT

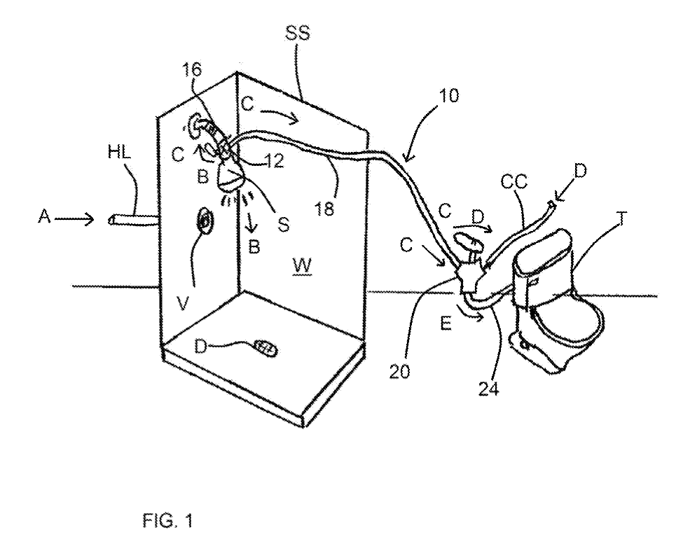

Turning now to the drawings and more particularly to FIG. 1, a typical installation for the present water conservation apparatus is illustrated generally at 10 in its operational environment. As discussed above, the water conservation apparatus is intended to put intermediate cold water which would otherwise be washed down the drain to good use. The intermediate cold water exists between the primary flow valve V and a hot water heater as will be seen in greater detail hereafter. It should also be noted that while the present invention is described using intermediate cold water intended for a shower, it could easily be fitted to a hot water line directed to a sink or other hot water distribution facility.

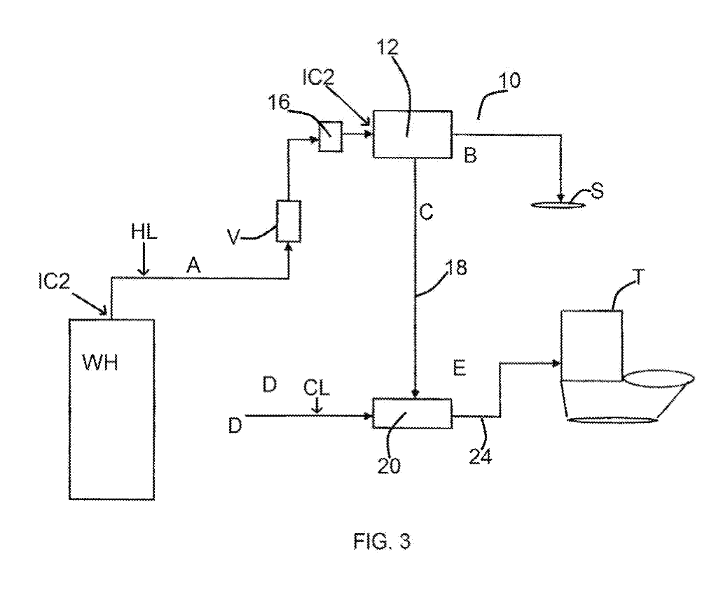

The environment described in FIG. 1 includes a shower stall SS having walls W and a drain D in the floor portion thereof. Hot water emergent form a water heater (designated WH in FIG. 3) is directed through a hot water line HL to the showerhead S. Also part of the environment is a toilet T which is normally fed cold water for its flush tank from a cold water line CL.

Hot water enters the environment through hot water line HL defining flow path A. Cold water enters the toilet environment through cold water line CL defining flow path D.

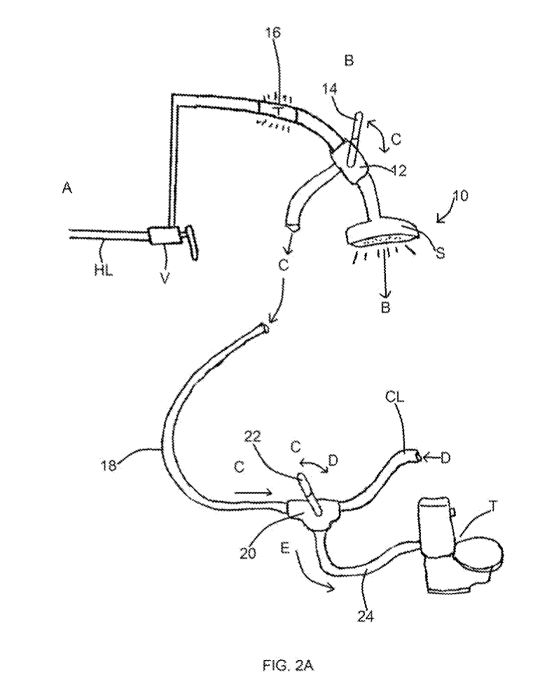

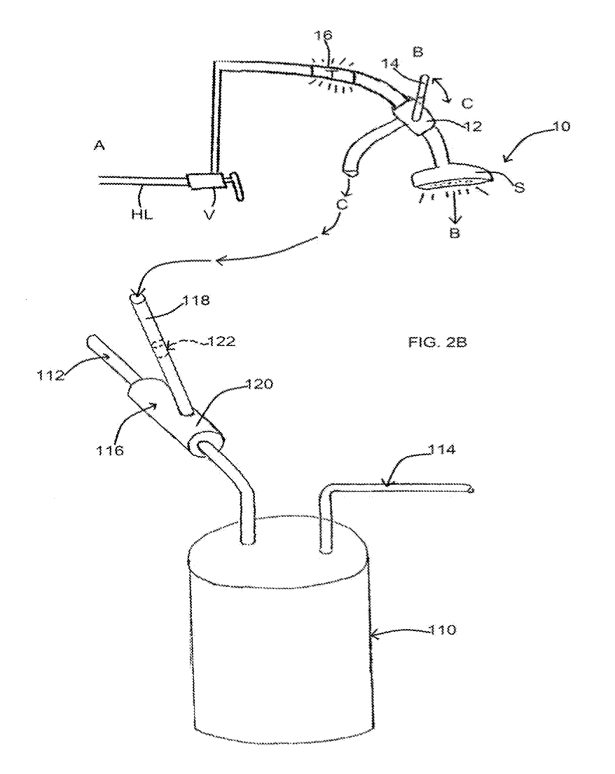

Further, the present invention may be installed in the shower stall/toilet environment without breaking walls or using exotic tools. Referring to FIGS. 1, 2A, and 3, the first preferred embodiment of the present invention is configured for a simple installation and includes a first valve 12 that is inserted in the water line between the showerhead S and primary flow valve V. A water transfer conduit 18 is attached to the first valve 12 and is in fluid communication with a second valve 20 disposed adjacent the toilet. The water directed to the toilet from the first valve 12 defines flow path C while water directed to the showerhead from the first valve 12 defines flow path B. The first valve 12 includes a valve handle 14, as best seen in FIG. 2A, that is moveable between a first position for selecting flow path B and a second position for selecting flow path C. The water transfer conduit 18 routes flow path C to the second valve 20 which is also equipped with a handle 22. The second valve 20 is movable between a first position for selecting flow path C and a second position for selecting flow path D to fill the toilet tank T. A conduit 24 extends from the second valve 20 of the toilet T and defines flow path E. FIG. 2A is particularly illustrative of the various flow paths A-E defined by the present invention.

A thermometer 16 is attached to the water line intermediate the primary flow valve V and the first valve 12. The thermometer 16 is preferably an adhesive-backed thermochromic thermometer that changes color when the water gets hot, thereby giving an indication of temperature change in the water entering the first valve 12. FIG. 2B illustrates a variation of the first preferred embodiment of the present invention wherein, in lieu of the flow path arrangement described with respect to FIG. 2A, an alternative flow path arrangement is provided. This alternative flow path arrangement includes a supplemental water feed system operable guide water flowing along the flow path C to a water heater 110 in lieu of guiding water to the toilet T. The water heater 110 may be any suitable commercially available water heater commonly found in residential households that is operable to receive fresh water via a fresh water inlet pipe 112 and to supply heated water to the household via a hot water supply pipe 114. The supplemental water feed system includes an inline coupling 116 installed on the fresh water inlet pipe 112 and a feed pipe 118 having one end communicated with the first valve 12 and the inline coupling 116. The inline coupling 116 comprises a sleeve portion 120 that mounts one end of the feed pipe 118 relative to the fresh water inlet pipe 112 such that this one end of the feed pipe 118 is communicated with the fresh water inlet pipe 112 in a leak-free manner at a location upstream of the connection of the fresh water inlet pipe 112 to the water heater 110. The one end of the feed pipe 118 communicated with the fresh water inlet pipe 112 includes a one-way or check valve 122 located upstream of the communication location. The flow path C in the variation shown in FIG. 2B extends from the first valve 12 to the water heater 110. In operation, fresh water flows along the fresh water inlet pipe 112 and is supplemented with water from the feed pipe 118, whereupon the combined flow of the fresh water and the water added from the feed pipe 118 thereafter flows into the water heater 110 for heating thereby. The check valve 122 eliminates any undesired diversionary flow of fresh water from the fresh water inlet pipe 112 into the feed pipe 118 in that the check valve 122 prevents upstream flow of water in a direction from the fresh water inlet pipe 112 toward the first valve 12. It can be understood that the inline coupling 116 can be configured such that fresh water flowing along the fresh water inlet pipe 112 creates a suction or Venturi effect that promotes the drawing in of water from the feed pipe 118 into the fresh water inlet pipe 112.

FIG. 3 provides a diagrammatic view of the first preferred embodiment of the present invention illustrated in FIGS. 1 and 2A. FIG. 3 includes a water heater WH that defines the origin of flow path A. It can also be seen that the hot water line HL extends from the water heater WH through the primary flow valve V and into the first valve 12. The water line between positions indicated at 101 and 102 define the portion of the conduit wherein the intermediate cold water resides. Once the primary flow valve V is open, hot water is emitted from the water heater at 101 and drives the predetermined volume of cold water toward the first valve 12.

In operation, and with reference to FIGS. 1 and 2A, the user operates the second valve 20 via valve handle 22 to divert water from the flow path D to flow path C entering the conduit 24 directed to the toilet tank T along flow path E. The user then operates the first valve 12 via the first valve handle 14 to divert water from flow path B, which would otherwise dispense the water from the showerhead S, to flow path C whereby water is directed toward the second valve 20. The user then operates the primary flow valve V, thereby allowing hot water to flow from the water heater WH to force the intermediate cold water along flow path A through the primary flow valve V past the thermometer 16 and into the first valve 12, and ultimately to the toilet tank T.

When the user observes the thermometer 16 indicating that the hot water has arrived, the user operates the first valve 12 to divert flow from flow path C back to flow path B for dispensing by the showerhead S. The second valve 20 then may be selected to flow path D as the origin for further water for the toilet tank T. This will eventually create a volume of intermediate cold water between the first valve 12 and the second valve 20. However, this will be dissipated in the next use of the water conservation apparatus.

Other variations of the present invention exist. Another preferred embodiment of the present invention may be installed in a bathroom under construction, such that the water lines may be hidden behind room walls and electrical power may be available. The utmost caution is always required when using electrical power around water and therefore, properly insulated circuitry is required. Second and third preferred embodiments differ with respect to operation of the first valve 12.

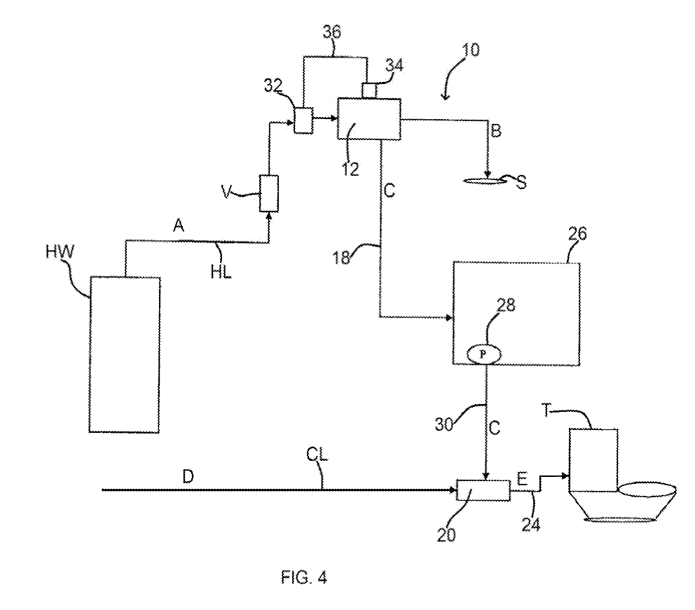

In the second preferred embodiment of the present invention, and with reference to FIG. 4, the first valve 12 includes a valve controller 34 and the thermometer is in the form of a temperature sensor 32 that is in operational electrical communication with the valve operator 34 to send a temperature-based signal 36 to the valve operator 34 for operation of the first valve 12 responsive to the temperature detected by the temperature sensor 32.

It should be noted that a valve controller 34 may include any sort of valve controller known in the art, such as a solenoid control or a motor drive. It will be apparent to those of ordinary skill in this art that the valve controller may be chosen based on local factors.

When the primary flow valve V is operated and the water passing the temperature sensor 32 is cold, i.e., below a predetermined temperature set point, the valve controller 34 maintains the valve in a position to direct flow along flow path C. When the hot water arrives from the hot water heater and the temperature sensor indicates that the water temperature has gone above a predetermined set point, the valve operator 34 operates the valve to change the flow path from flow path C to flow path B which ultimately results in the showerhead as dispensing the water for use by the user. The temperature control trigger arrangement described above requires electric power to operate, therefore such an automatic triggering system would benefit from installation during bathroom construction.

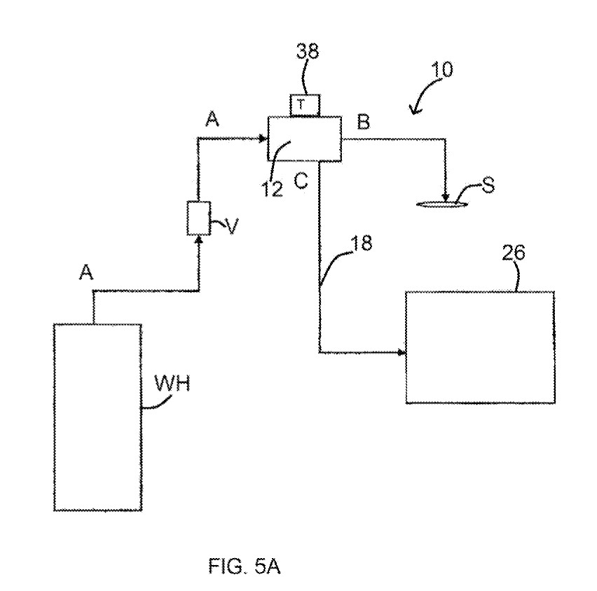

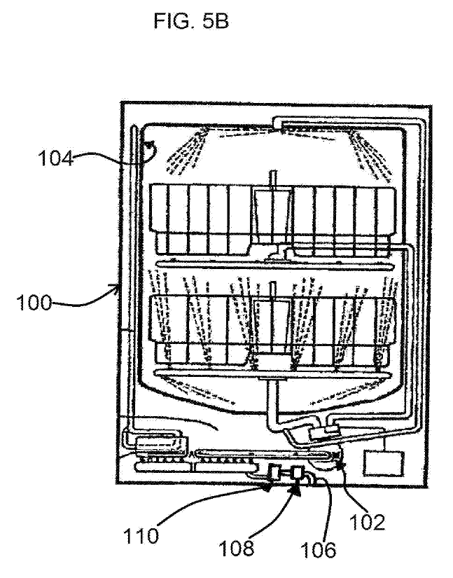

Referring now to FIG. 5A, a third preferred embodiment of the present invention is illustrated and instead of the temperature-based trigger arrangement, a timer 38 is used to control the valve controller 34 indicating that the valve operation should occur after a predetermined elapsed time. The timer-based system may lend itself to a more mechanical application in that the timer may be set by the user for a predetermined time period. Accordingly, when the user operates the primary flow valve V, the user may also set the timer 38 which also operates the first valve 12 to direct flow from flow path B to flow path C. Once the timer 38 has reached the end of the elapsed time, the valve is operated once again to direct flow from flow path C to flow path B for distribution by the showerhead S and use by the user. Such a mechanically set timer could be configured by those of ordinary skill in the art to mechanically operate the first valve 12. In addition to the foregoing, the timer may be electronic and the valve controller may be the same valve controller 34 from the second embodiment of the present invention operable from a time-based electrical trigger signal instead of a temperature-based electrical trigger signal.

Either the first, second or third embodiments of the present invention will accomplish the task of routing the intermediate cold water away from the showerhead S to a path toward more useful purpose. The first, fully manual embodiment is the least expensive embodiment to produce and obtain while the mechanical timer version described above would be the next least expensive version to produce and obtain. Finally, the electronic temperature sensor and timer versions would be the most expensive embodiment to produce and obtain. Such multiple embodiments provide a wide choice for ultimate producers, purchasers and users of the present invention.

Other variations on the present invention include the ultimate use aspects of the invention with respect to the intermediate cold water. The usage to fill a toilet is especially expedient in a bathroom, providing assured conservation of water and the user never has to physically encounter the intermediate cold water volume. On the other hand, other uses of the intermediate cold water are available beyond filling a toilet tank. For those uses, a holding tank 26 is provided. The holding tank 26 may be used alone as seen in FIG. 5A or may be positioned intermediate the first valve 12 and the second valve 20, as seen in FIG. 4.

Each of the two noted variations may include a storage vessel or holding tank 26 between the toilet T and the first valve 12. This necessitates another conduit 30; however, the flow path from the first valve through the storage tank 26 to the second valve remains flow path C. In times where the flow is interrupted and the toilet requires water from the holding tank, a pump 28 is provided to pump the holding tank 26 toward the second valve 20 and ultimately through the conduit 24 to the toilet tank T. As can be seen, electrical power would be required for the pump and the valve controller as well as the thermometer which is also electric. Therefore, while a skilled homeowner could install such a system, the first embodiment of the present invention provides more of a do-it-yourself kit while the second and third preferred embodiments, as will be seen, are more suited to installation during construction. FIG. 5A includes the holding tank 26 and instead of a thermometer, a timer is indicated at 38 for operation of the first valve 12 after a predetermined time has elapsed. The timer 38 will likely not require electrical power although it cannot be ruled out.

The holding tank 26 may be configured in the manner illustrated in FIG. 4 for pumping water to the second valve 20. However, it is contemplated that this embodiment of the present invention collects the intermediate cold water in a cold water storage tank 26 which may be drained for later use such as mop water, dog water or other cleaning purposes.

According to the method, the present invention includes steps for conserving water using a closed system water conservation apparatus for connection to a hot water supply and delivery system including a hot water conduit in communication with both a hot water heater and a delivery opening defining a first water path A with the water delivery being controlled by a primary flow valve. The method includes the steps of:
initiating water flow using the primary flow valve V;
operating the first valve 12 to divert water from path B to path C leading to a holding tank 26 to prevent water from exiting the showerhead S and for retaining the water in the holding tank 26 for later use;
monitoring water temperature using a temperature sensing arrangement 32 for sensing a temperature of fluid within the hot water conduit; and
operating the first valve when an observed temperature of the water within the hot water conduit reaches a predetermined temperature to direct water to the delivery opening.

Referring now to FIG. 5B, a fourth preferred embodiment of the present invention is illustrated that exemplarily shows in a general manner one possible deployment scenario of the water conservation apparatus of the present invention installed in a household appliance. A dishwasher 100 has a spray system 102 operable to spray rinsing water on dishes and cutlery retained in a washing chamber 104 of the dishwasher. The spray system 102 is connected via a hot water inlet coupling 106 to a hot water supply source (not shown) such as, for example, a hot water pipe of a home residence. The water conservation apparatus is provided as a valve 108 and associated structure communicated with the hot water inlet coupling 106 and communicated as well with an internal appliance control valve 110 that controls the introduction of hot water into the spray system 102.

As can be seen from the foregoing, the present invention provides at least four preferred embodiments of the invention with other variations possible. The receiving section may include the holding tank 26 or be directed straight to the toilet. In addition, the toilet may be eliminated altogether from the system.

By the above, the foregoing provides a water conservation apparatus that may appear for simple installation by a homeowner or may appear in a more complex form for installation during construction or remodeling. In either form, the present invention provides a water conservation measure that eliminates water being tossed down the drain without useful purpose.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A closed system water conservation apparatus for connection to a hot water supply and delivery system including a hot water conduit in communication with a hot water heater and a delivery opening wherein standing water intermediate the hot water heater and the delivery opening can become cold water; and a cold water supply and delivery system, including a cold water conduit in fluid communication with a cold water source and a toilet having a flush water tank, the water conservation apparatus comprising:
a first valve disposed along the hot water conduit upstream of the delivery opening for selectively directing water between a first path for receipt and distribution by the delivery opening and a second path for use by the toilet;
a second valve disposed along the hot water conduit upstream of the toilet, the second valve being in fluid communication with the cold water source and the first valve for selectively directing water to the toilet from at least one of the second path and the cold water source; and
a water transfer conduit extending in fluid communication between the first valve and the second valve along the second path for intermediate cold water flow therethrough between the first valve and the second valve, wherein the water conservation apparatus is configured for selectively directing intermediate cold water from the hot water conduit to the second primary flow valve via the water transfer conduit and wherein the second valve is configured for selectively receiving the intermediate cold water from the hot water conduit via the first valve and directing the intermediate cold water to the flush water tank, and for selectively directing hot water from the hot water source to the delivery opening via the hot water conduit.

2. A water conservation apparatus according to claim 1 and further comprising a thermometer in operational communication with the hot water conduit disposed upstream of the first valve, the thermometer having an arrangement for presenting an indication of a temperature of the hot water conduit thereby providing an indication of a temperature of a fluid within the conduit.

3. A water conservation apparatus according to claim 2 wherein the thermometer is a human readable thermometer adhesively fixed to the hot water conduit and configured for presenting an indication of a temperature of a fluid within the conduit.

4. A water conservation apparatus according to claim 1 wherein the first valve includes a temperature sensor disposed in operational communication with the hot water conduit upstream of the first valve for sensing a temperature within the hot water conduit upstream of the first valve and an automatic valve operator arrangement in operational communication with the temperature sensor for operating the first valve to direct water from the first path to the second path when the temperature sensor has sensed a temperature indicating cold water present in the hot water conduit upstream of the first valve, and for operating the valve to direct water from the first path to the delivery opening when the temperature sensor has sensed a temperature indicating hot water present in the hot water conduit upstream of the first valve.

5. A water conservation apparatus according to claim 1 wherein the first valve includes a timer for counting a predetermined elapsed time and producing a valve control signal responsive to the completion of the predetermined elapsed time, the timer being disposed in operational communication with an automatic valve operator arrangement for operating the first valve to direct water from the first path to the second path when the timer is started and operating the valve to direct water from the second path to the first path and to the delivery opening when the control signal indicates completion of the predetermined elapsed time.

6. A water conservation apparatus according to claim 1 and further comprising a holding tank disposed along the water transfer conduit in fluid communication therewith for selective retention of intermediate cold water from the hot water conduit via the first valve and the water transfer conduit.

7. A water conservation apparatus according to claim 6 and further comprising a pump in operational communication with the holding tank for selectively moving water from the holding tank to the toilet tank.

8. A closed system water conservation apparatus for connection to a hot water supply and delivery system including a hot water conduit in communication with a hot water heater and a delivery opening, the water conservation apparatus comprising:
a trigger arrangement operatively associated with the hot water conduit, the trigger arrangement including at least one of an arrangement for determining a temperature of fluid within the hot water conduit and an arrangement for determining an elapsed time, the trigger arrangement being configured for producing a trigger signal responsive to one of at least one predetermined temperature and a predetermined elapsed time;
a first valve disposed along the hot water conduit upstream of the delivery opening along a first path to the delivery opening for selectively directing intermediate cold water between the first path for receipt and distribution by the delivery opening and a second path, the first valve including an automatic valve operator in operational communication with the trigger arrangement for operating the first valve when the control signal indicates whether at least one of the timers has been started and the temperature of the water is at a first predetermined value thereby indicating intermediate cold water is present in the hot water conduit and for operating the first valve when at least one of the temperatures is at a second predetermined value and the timer indicating that a predetermined elapsed time has passed thereby indicating that hot water is present in the hot water conduit upstream of the delivery opening to direct water to the delivery opening; and
a holding tank disposed along the second path in fluid communication with the first valve for selective retention of intermediate cold water from the hot water conduit via the first valve and a water transfer conduit wherein the water conservation apparatus is configured for selective direction of intermediate cold water from the hot water conduit to the holding tank via the water transfer conduit, and for selectively directing hot water from the hot water source to the delivery opening via the hot water conduit responsive to control signals from the trigger arrangement.

9. A water conservation apparatus according to claim 1 wherein the trigger arrangement includes a thermometer in operational communication with the hot water conduit disposed upstream of the first valve, the thermometer having an arrangement for presenting an indication of a temperature of the hot water conduit thereby providing an indication of a temperature of a fluid within the conduit.

10. A water conservation apparatus according to claim 2 wherein the thermometer is a human readable thermometer adhesively fixed to the hot water conduit and configured for presenting an indication of a temperature of a fluid within the conduit.

11. A water conservation apparatus according to claim 1 wherein the first valve includes a timer for counting a predetermined elapsed time and producing a valve control signal responsive to the completion of the predetermined elapsed time, the timer being disposed in operational communication with an automatic valve operator arrangement for operating the first valve when a valve control signal indicates completion of the predetermined elapsed time.

12. A method for conserving water using a closed system water conservation apparatus for connection to a hot water supply and delivery system including a hot water conduit in communication with both a hot water heater and a delivery opening defining a first water path, the water delivery being controlled by a primary flow valve, the method comprising the steps of:
initiating water flow using the primary flow valve;
operating a first valve disposed along the hot water conduit upstream of the delivery opening to divert water from the first path to a second path leading to a storage vessel to prevent water from exiting the delivery opening and for retaining the water in the storage vessel for later use;
monitoring water temperature using a temperature sensing arrangement disposed along the hot water conduit upstream of the delivery opening for sensing a temperature of fluid within the hot water conduit; and
operating the first valve when an observed temperature of the water within the hot water conduit reaches a predetermined temperature to direct water to the delivery opening.

13. A water conservation method according to claim 12 and further comprising the step of operating a second valve disposed along the second path to direct the intermediate cold water from the second path to a storage vessel.

14. A water conservation method according to claim 12 and further comprising the step of operating a second valve disposed along the second path to direct the intermediate cold water from the second path to a storage tank operatively associated with a flush toilet.

15. A water conservation method according to claim 12 and further comprising the step of operating a second valve disposed along the second path to direct the intermediate cold water from the second path to a holding tank for later use.

16. A water conservation method according to claim 12 wherein the step of monitoring water temperature using a temperature sensing arrangement includes using a temperature sensor operatively connected to a valve control device for controlling the operative disposition of the first valve and the step of operating the first valve includes changing the operative disposition of the valve responsive to at least one predetermined temperature set point as determined by the temperature sensing arrangement.
